(19) United States
(12) Patent Application Publication
(10) Pub. No.: US 2010/0317280 A1
(43) Pub. Date: Dec. 16, 2010

(54) BEVERAGE BOTTLING PLANT OR FOODSTUFF CONTAINING ELEMENT FILLING PLANT EACH HAVING A CLEAN ROOM AND EACH HAVING APPARATUS FOR ASSISTING IN THE CLEANING OF THE CLEAN ROOM, AND A METHOD OF CLEANING THE CLEAN ROOM

(76) Inventor: Thomas Detemple, Planegg (DE)

Correspondence Address: NILS H. LJUNGMAN & ASSOCIATES, P. O. BOX 130, GREENSBURG, PA, 15601-0130, US

(21) Appl. No.: 12/818,801

(22) Filed: Jun. 18, 2010

Related U.S. Application Data
(63) Continuation-in-part of application No. PCT/EP2008/009918, filed on Nov. 22, 2008.

(30) Foreign Application Priority Data
Dec. 21, 2007 (DE) 10 2007 062 813.9

(51) Int. Cl. B01L 1/04; B65B 7/16

(52) U.S. Cl. 454/187; 53/284.5

(57) ABSTRACT

A beverage bottling plant and foodstuff containing element filling plant each having a clean room and each having apparatus for assisting in the cleaning of the clean room, and a method of cleaning the clean room. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2008/009918, filed on Nov. 22, 2008, which claims priority from Federal Republic of Germany Patent Application No. 10 2007 062 813.9, filed on Dec. 21, 2007. International Patent Application No. PCT/EP2008/009918 was pending as of the filing date of this application. The United States was an elected state in International Patent Application No. PCT/EP2008/009918.

### BACKGROUND

1. Technical Field

The present application relates to a beverage bottling plant or foodstuff containing element filling plant each having a clean room and each having apparatus for assisting in the cleaning of the clean room, and a method of cleaning the clean room.

2. Background Information

Background information is for informational purposes only and does not necessarily admit that subsequently mentioned information and publications are prior art.

There are a series of applications in which it may be desired to provide machines with a so-called housing. This may be desired for different reasons, for instance for sound insulation, for protection against spray if liquids are used and as a barrier in order to minimize the accidental or unauthorized approach to the correspondingly housed machines.

When foodstuffs are being packaged there is already a desire for such a housing purely for reasons of hygiene. In this case there is a border or barrier around the machines in order to protect corresponding transport sections inside a production, filling and packaging system, not least on account of environmental protection and safety at work.

These types of housings provide a clean room.

In situations where machines are processing foodstuffs, they are usually intensively cleaned, e.g. using high-pressure cleaners, efforts obviously being made to discharge all or substantially all particles of dirt, for instance accumulating shards in the case of machines using glass or bottles, out of the housing, for which the corresponding areas are sometimes opened up in order to perform the cleaning.

### OBJECT OR OBJECTS

This is where the present application fits in, an object of which, in at least one possible embodiment, is to greatly simplify the cleaning using high-pressure cleaners in that the partition wall is developed for the discharging of dirt and the like such that none of the partition walls may be handled.

### SUMMARY

This object is achieved according to the present application in that the glass panels or partition wall elements are positioned on stand elements in such a manner that a gap is formed between the floor surface and the bottom edge of the partition wall elements and that gap plates are provided in said gap, the gap plates bridging the gap and being displaceable by means of hinges.

These types of displaceable gap plates, on the one hand, provide the desired closure of the partition wall in relation to the support floor; on the other hand, however, these displaceable gap plates make it possible for dirt particles, glass shards, whole bottles and the like to be able to be flushed through under the partition wall using a high pressure cleaner, as the gap plates then open automatically when impinged upon, for instance, by a high pressure water jet and subsequently by means of the hinges fall back into their closed position.

In at least one possible embodiment of the present application, it can be provided that the hinges of the gap plates are provided at the stand elements of the partition walls, which simplifies the production and the design of such elements.

According to the present application it can also be provided that the mounting of the gap plates makes it possible for the gap plates to pivot up in the direction of outside the interior space that is formed by the partition walls whilst avoiding pivoting into the room that has been formed.

The gap plates may be formed, in at least one possible embodiment of the present application from a material that can easily be cut or bent for adapting to the respective installation situation, for instance when the partition walls have to overcome an inclined floor covering, small steps or the like. In this case, the gap plate can be, in at least one possible embodiment, easily adapted to the local conditions at the place of installation.

If a corresponding device is used in bottle filling systems, the present application then provides that in the position of use the width of the gap plates is at least the width of a horizontal bottle, it also being possible to provide that by way of the outer edges the gap plates follow the course of the stands of the partition wall elements.

The present application is concerned with a partition wall, in at least one possible embodiment for the housing of packaging machines for foodstuffs, for forming a clean room from a plurality of partition wall elements, in at least one possible embodiment of the present application glass panels.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is explained below in a manner by way of the drawing, in which, in detail:

FIG. 1 shows a simplified three-dimensional representation of a section from a partition wall according to the present application in an exterior view;

FIG. 2 shows an interior view of a partition wall part;

FIG. 3 shows a basic schematic plan view of a clean room filling device, which may utilize the partition wall of the present application;

FIG. 4 shows schematically the main components of one possible embodiment example of a system for filling containers, for example, a beverage bottling plant for filling bottles with at least one liquid beverage, in accordance with at least one possible embodiment, in which system or plant could possibly be utilized at least one aspect, or several aspects, of the embodiments disclosed herein;

FIG. 5 is a simplified view in elevation of a plant comprising the partition wall parts of the present application for the aseptic bottling of a liquid in bottles or similar containers;

FIG. 6 shows an interior view of a partition wall part with seals or sealing arrangements;

FIG. 7 shows an interior view of a partition wall part with hinges or hinge means; and

FIG. 8 is a block diagram of a nozzle or sprayer and the gap plates of the present application.

### DESCRIPTION OF EMBODIMENT OR EMBODIMENTS

The partition wall given the general reference 1 is shown as a section in the possible embodiment represented, in this case with three glass panels forming the partition wall elements 2.

In the example represented, the individual partition wall elements 2 are on stand elements or wall supports 3. The height of the partition wall element 2 is modifiable.

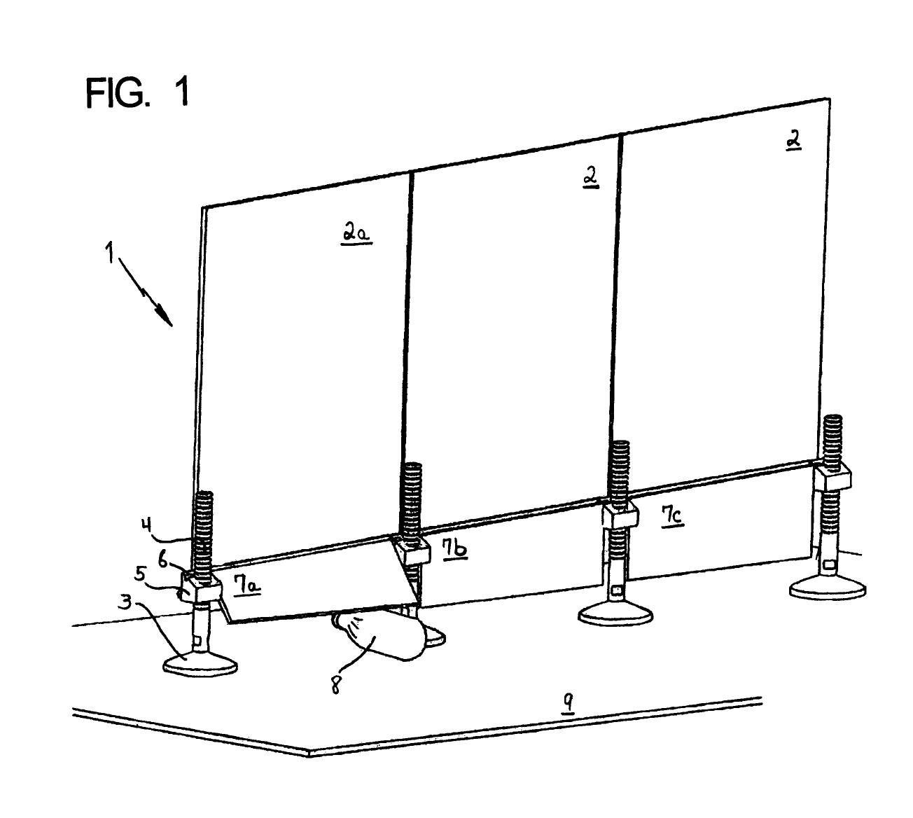

Bearing elements 5, provided with internal thread and realized as blocks, are positioned around the stands 3 provided with threaded elements 4, the pitch being taken up by rotating the threaded elements, said bearing elements having supports 6 for pivot pins (not shown in any more detail) on the edges of gap plates 7 on the edge contour that points to the outside in the position of use, in such a manner that the gap plates 7 can be mounted at that location by way of the pivot pins 7, which makes possible a movement out of the mounted position into a pivoting-out position, as is represented in FIG. 1 on the partition wall element given the reference 2a. The gap plate at that location bears the reference 7a and, in the example represented, rests on a bottle 8 that has been flushed towards the outside during the cleaning process, which, if it is contacted by a cleaning jet of a high pressure cleaner, will be moved to the outside.

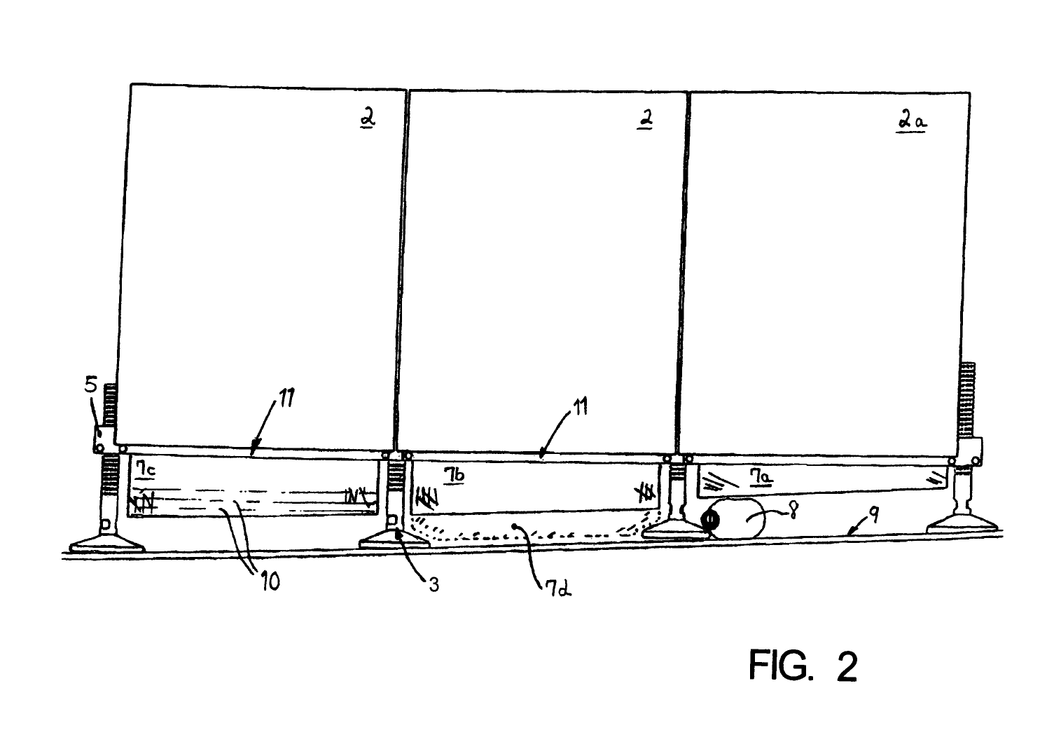

It can also be recognized in FIG. 1 that the gap plates 7a, 7b and 7c have various widths as they are associated with an inclined ground surface 9. In order to make this adaptation easier, the gap plates 7 are made from a material that can be easily cut, for example, or there are predetermined break points 10 at corresponding spacings, as is indicated on the gap plate 7c in FIG. 2.

In FIG. 2 it is also indicated by the dots on gap plate 7b, that said plate, as it can easily be cut, is also adaptable to the shape of the stands or stand elements 2. This region is identified by the reference 7d in FIG. 2.

As indicated in FIG. 2, supporting beams 11, which hold the partition wall elements 2, are associated with the threaded blocks 5.

On account of the special mounting of the gap plates 7, the plates 7 are able to pivot up to one side in the manner represented in FIG. 1, but the return pivoting movement may be restricted and/or minimized by the support beam 11 in such a manner that the gap plates 7 are able to pivot up into the direction facing away from the support beams 11.

Naturally, the described embodiment of the present application can still be amended in many respects without departing from the basic concept. Thus, the present application is not restricted to the type of the stands and adjusting feet represented as support elements, nor to the type and development of the gap plates and the like.

The present application relates to a partition 1, in at least one possible embodiment for housing packaging machines for food, for forming a clean room from a plurality of partition wall elements, particularly glass panes. Cleaning by means of high-pressure cleaners should be simplified in that, in order to remove contamination and the like, the partition wall is designed so that no special manipulation of all the partitions is needed. The aim is achieved in that the glass panes or partition elements 2 are positioned on stand elements 3, 4, such that a gap is formed between the floor surface 9 and the lower edge of the partition wall elements 2. The gap plates 7, movable by hinges and bridging the gap, are provided in the gap formed between the floor surface 9 and the lower edge of the partition wall elements 2.

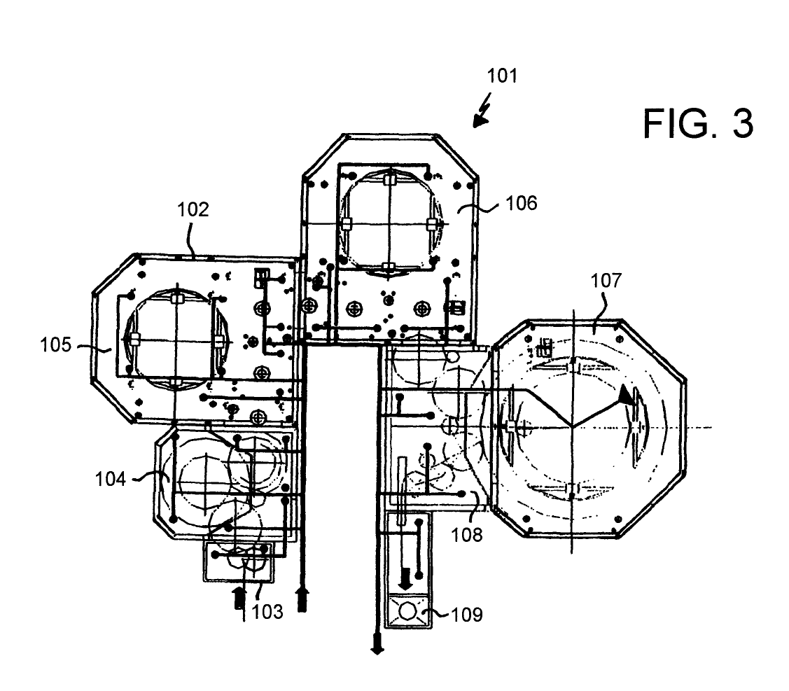

FIG. 3 may show one possible embodiment of a filling plant for filling and closing glass bottles in a clean room. The walls of the clean room may comprise the wall partitions of the present application. A machine designated in its entirety as 101 for the filling of containers, for example for bottles or cans with beverages, etc., is shown in greater detail in FIG. 3. The complete machine may be enclosed in a housing 102, which may protect the entire interior from contaminants from the outside so that clean room conditions prevail in the interior.

The machine 101 may comprise a container opening 103, through which the bottles to be filled may gain admission to the interior of the machine. The containers may then be sterilized in a sterilization device 104. The containers may move around a circular track together with a plurality of vaporization heads that may direct vaporous H₂O₂ into the interior and the upper outer region of the container. Due to the temperature differences between the vaporized H₂O₂ and the wall of the container, the sterilizing agent may precipitate and form a condensation film. The containers may then be conveyed into a first activation device 105, in which hot air or hot steam may be directed against the outside or the inside of the container. This may initiate a decomposition reaction in the deposited H₂O₂, in which it may decompose via a number of intermediate steps. During the reaction, any germs or impurities present may be attacked and broken down by the reaction products produced intermittently, until essentially only water and a few residual decomposition products may remain.

Because the reaction requires and/or desires some time, once the containers have completed a partial rotation through the first activation device 105, the containers may also complete another rotation in a second activation device 106 downstream of the first, so that there may be sufficient time for the decomposition reaction to be completed when the end of the second activation device 6 is reached. The bottles may then move into a filling device 107, in which the bottles may be filled as they move around the machine before they may be closed in a closing device 108. They then may leave the bottling machine through the container outlet 109.

To maintain the clean room conditions in the interior of the machine 101, the interior must be or should be sterilized periodically. The method according to the present application may be performed as follows:

First productive operation of the machine may be stopped, in one possible embodiment the supply of bottles may be interrupted and the various machines in the interior of the machine 101 may be shut down. The cleaning cycle may then be started.

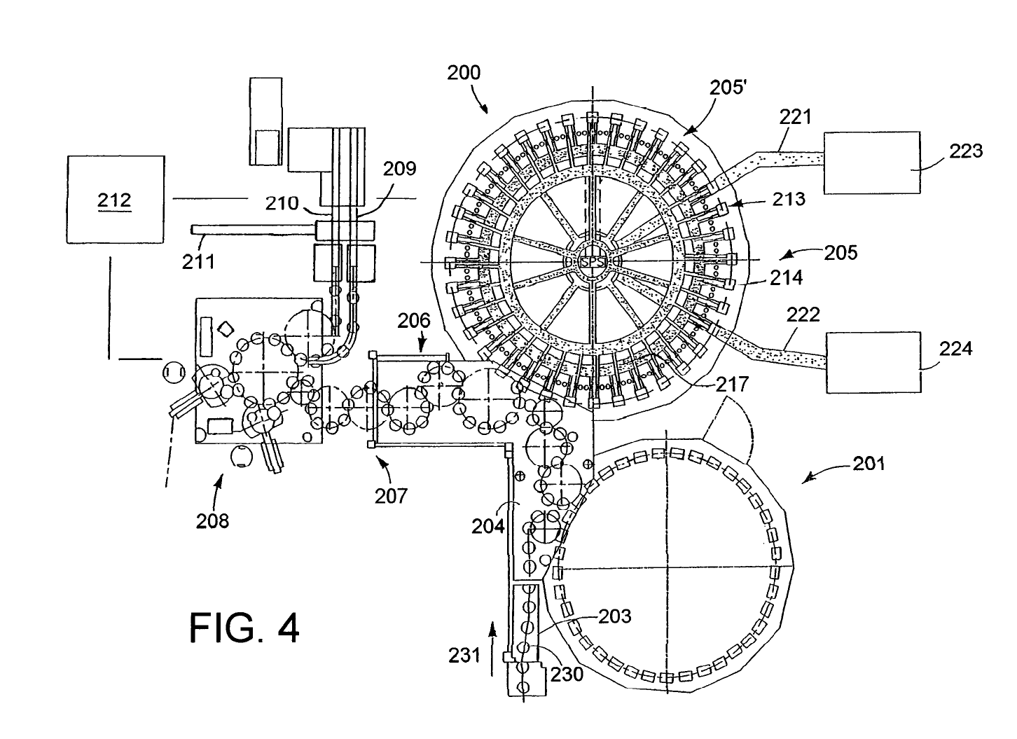

FIG. 4 shows schematically the main components of one possible embodiment example of a system for filling containers, specifically, a beverage bottling plant for filling bottles 230 with at least one liquid beverage, in accordance with at least one possible embodiment, in which system or plant could possibly be utilized at least one aspect, or several aspects, of the embodiments disclosed herein.

FIG. 4 shows a rinsing arrangement or rinsing station 201, to which the containers, namely bottles 230, are fed in the direction of travel as indicated by the arrow 231, by a first conveyer arrangement 203, which can be a linear conveyor or a combination of a linear conveyor and a starwheel. Downstream of the rinsing arrangement or rinsing station 201, in the direction of travel as indicated by the arrow 231, the rinsed bottles 230 are transported to a beverage filling machine 205 by a second conveyer arrangement 204 that is formed, for example, by one or more starwheels that introduce bottles 230 into the beverage filling machine 205.

The beverage filling machine 205 shown is of a revolving or rotary design, with a rotor 205′, which revolves around a central, vertical machine axis. The rotor 205′ is designed to receive and hold the bottles 230 for filling at a plurality of filling positions 213 located about the periphery of the rotor 205′. At each of the filling positions 203 is located a filling arrangement 214 having at least one filling device, element, apparatus, or valve. The filling arrangements 214 are designed to introduce a predetermined volume or amount of liquid beverage into the interior of the bottles 230 to a predetermined or desired level.

The filling arrangements 214 receive the liquid beverage material from a toroidal or annular vessel 217, in which a supply of liquid beverage material is stored under pressure by a gas. The toroidal vessel 217 is a component, for example, of the revolving rotor 205′. The toroidal vessel 217 can be connected by means of a rotary coupling or a coupling that permits rotation. The toroidal vessel 217 is also connected to at least one external reservoir or supply of liquid beverage material by a conduit or supply line. In the embodiment shown in FIG. 4, there are two external supply reservoirs 223 and 224, each of which is configured to store either the same liquid beverage product or different products. These reservoirs 223, 224 are connected to the toroidal or annular vessel 217 by corresponding supply lines, conduits, or arrangements 221 and 222. The external supply reservoirs 223, 224 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 214 could be connected by separate connections to each of the two toroidal vessels and have two individually-controllable fluid or control valves, so that in each bottle 230, the first product or the second product can be filled by means of an appropriate control of the filling product or fluid valves.

Downstream of the beverage filling machine 205, in the direction of travel of the bottles 230, there can be a beverage bottle closing arrangement or closing station 206 which closes or caps the bottles 230. The beverage bottle closing arrangement or closing station 206 can be connected by a third conveyer arrangement 207 to a beverage bottle labeling arrangement or labeling station 208. The third conveyor arrangement may be formed, for example, by a plurality of starwheels, or may also include a linear conveyor device.

In the illustrated embodiment, the beverage bottle labeling arrangement or labeling station 208 has at least one labeling unit, device, or module, for applying labels to bottles 230. In the embodiment shown, the labeling arrangement 208 is connected by a starwheel conveyer structure to three output conveyer arrangements: a first output conveyer arrangement 209, a second output conveyer arrangement 210, and a third output conveyer arrangement 211, all of which convey filled, closed, and labeled bottles 230 to different locations.

The first output conveyer arrangement 209, in the embodiment shown, is designed to convey bottles 230 that are filled with a first type of liquid beverage supplied by, for example, the supply reservoir 223. The second output conveyer arrangement 210, in the embodiment shown, is designed to convey bottles 230 that are filled with a second type of liquid beverage supplied by, for example, the supply reservoir 224. The third output conveyer arrangement 211, in the embodiment shown, is designed to convey incorrectly labeled bottles 230. To further explain, the labeling arrangement 208 can comprise at least one beverage bottle inspection or monitoring device that inspects or monitors the location of labels on the bottles 230 to determine if the labels have been correctly placed or aligned on the bottles 230. The third output conveyer arrangement 211 removes any bottles 230 which have been incorrectly labeled as determined by the inspecting device.

The beverage bottling plant can be controlled by a central control arrangement 212, which could be, for example, computerized control system that monitors and controls the operation of the various stations and mechanisms of the beverage bottling plant.

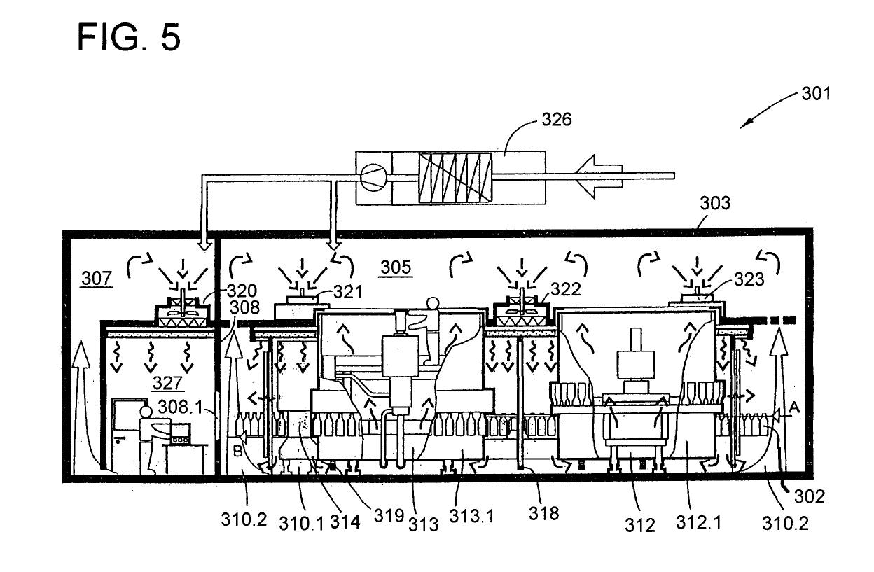

The plant designated 301 in general in FIG. 5 is used for the aseptic bottling of a liquid in containers or bottles under clean room conditions, for example of a sensitive and/or highly perishable liquid such as a milk product, fruit juice or similar product, for example, or for the bottling of pharmaceutical products.

The plant 301 comprises essentially an outer housing 303 which encloses an interior which is essentially tightly closed from the exterior, and which is divided into an upper area and a lower area by a false floor/ceiling. The upper area forms, over the larger portion of the horizontal projection in FIG. 5, a plenum 305 (ceiling space or intermediate room) and an auxiliary room 307 which is separated from the plenum 305. Both the plenum 305 and the auxiliary room 307 are tall enough that the rooms can be entered by persons standing upright, e.g. to perform repair or maintenance work.

The space below the false floor/ceiling is divided by vertical walls 308 with sealed windows 308.1 into, among other things, a personnel entry airlock and a sterile space, which in the plant illustrated in FIG. 5 is located below the plenum 305. For its part, the sterile room is in turn divided by a partition or insulating wall that encloses the machines used in the plant 301 into an inner clean room area 310.1 and an outer security area 310.2.

The partition or insulating wall is realized, at least in part, in the form of a glass wall, so that the machines that are installed in the clean room segment 310.1 are visible from the security area 310.2, and thus the proper operation of these machines, among other things, can be observed.

In at least one possible embodiment of the application, the partition or insulating walls may be the partition walls according to the present application, which comprise the wall parts 2 and 2a an the gap plates 7a, 7b, and 7c.

In the illustrated embodiment, in the clean room area 310.1 there are a rinser 312 which, among other things, sterilizes the bottles 302 that have already been cleaned, a filling machine 313 to fill the sterilized bottles 302 with the liquid to be bottled, a capper 314 to close the bottles and transport devices to transport the bottles 302 between the rinser 312, the filling machine 313 and the capper 314. The rinser 312, the filling machine 313 and the capper 314 are all machines with a rotary design and a rotating rotor.

The empty bottles 302 are fed in the direction indicated by the Arrow A in FIG. 5 by means of a conveyor over the security area 310.2 and through an opening or lock in the wall to the rinser 312. The filled and capped bottles are transported away in the direction indicated by the Arrow B in FIG. 5 by means of the conveyor through an opening or airlock in the wall, first into the security area 310.2 and from there out of the housing 303.

The wall hermetically seals the clean room area 310.1, including the vicinity of the underside of the false floor/ceiling, off from the security area. In the vicinity of the floor, there are openings in the wall for the passage of air from the clean room area 310.1 into the security area 310.2.

The rinser 312 and the filling machine 313 each have a shield wall or cylindrical shield 312.1 or 313.1 that enclose the respective machine and/or its rotor. These shields are each essentially in the shape of a hollow cylinder that lies with its axis equi-axial with the vertical machine axis and is open on the bottom and top of the machine. Because the machines generally stand on the floor with feet, the lower edge or the bottom opening of each shield 312.1 or 313.1 is at some distance from the floor, so that between the floor and the lower edge of each shield 312.1 and 313.1 there is a ring-shaped opening for the entry of air from the space surrounding the respective machine into the interior of the shield 312.1 or 313.1. In the vicinity of the upper end, the shields 312.1 and 313.1 are connected in a sealed manner through the false floor/ceiling, where they are covered by a grid or screen 312.2 or 313.2, for example, so that although air can flow out of the interior of the respective cover 312.1 or 313.1 into the plenum 305, the false floor/ceiling is still accessible in the area of the shields 312.1 and 313.1.

The cylindrical shields 312.1 and 313.1 provide several advantages. In one possible embodiment, the cylindrical shields 312.1 and 313.1 can extend all the way to, and possibly beyond, the false floor/ceiling. Such a design essentially encloses the annular space above the rinser and the filling machine, thus minimizing the space of the clean room where sterile air needs to continuously be introduced and to continuously flow. Further, the cylindrical shields 312.1 and 313.1 minimize or substantially reduce the size of the clean room area where sterile air needs to continuously be introduced and to continuously flow. Without the shields 312.1 and 313.1, sterile air would need to occupy a substantially larger area of the clean room, which would require more work from the filters 321, 322, and 323 and distribution ducts associated with the filters 321, 322, 323. A smaller area to fill with sterile air would result in lower energy use, lower costs, and less wear and tear on the filters and distribution ducts, possibly resulting in fewer repairs and less maintenance work.

A further advantage of the extension of the cylindrical shields 312.1 and 313.1 to or beyond the false floor/ceiling is that access is permitted to the machines inside the shields for maintenance or repair purposes. Further, since the cylindrical shields 312.1 and 313.1 sit off the floor and create a ring-shaped space around their respective machines, sterile air is permitted to flow from the clean room area surrounding the shields 312.1 and 313.1, through the ring-shaped space. The air then moves upward into the inside of the shields, then out through vents in the false floor/ceiling. This special upward flow of sterile air permits repairs or maintenance to be performed to the machines on the inside of the shields 312.1 and 313.1 without contaminating the sterile air in the clean room.

A further advantage of the cylindrical shields 312.1 and 313.1 is the protection of the sterile air in the clean room area from contaminates which may be generated from the rinser or filling machine. Since the rinser and filling machine operate within the confines of the shields 312.1 and 313.1, and the air inside the shields flows up and out through a vent in the false floor/ceiling, any airborne contaminates generated by the machines flow out and away from the sterile environment. The machines are effectively substantially sealed off from the clean room area, and any contaminates produced during the machines' operation are essentially kept from entering the clean room area and contaminating the sterilized air therein.

In the clean room area 310.1 there are additional partitions 318 and 319, and in particular a partition 318 between the rinser 312 and the filling machine 313, as well as a partition 319 between the filling machine 313 and the capper 314. In the illustrated embodiment, the partitions each form air passage openings on the floor. They also have openings to make possible the transfer of bottles between the individual sections.

In the false floor/ceiling there are a plurality of filtering devices 320, 321, 322, and 323 to produce sterile air by filtering. The filtering devices 320, 321, 322, and 323 are used not only for filtering, but can also be used to heat or cool the air. In addition to a filter and a fan, in such an application there can also be a heating or cooling element that is formed by a heat exchanger.

By means of the filtering device 320, air is sucked out of the auxiliary space 307 and filtered, i.e. it is introduced into the personnel entry airlock in the form of sterile air. In the vicinity of the bottom, the personnel entry airlock has an air outlet opening that empties into a vertical air duct, by means of which the air can flow out of the personnel entry airlock back into the auxiliary room 307.

With the filter device 321, air is sucked out of the plenum 305 and filtered, i.e. the greater part of it is blown in the form of sterile air into the portion of the clean room area 310.1 that is occupied by the capper 314, and partly also into a hollow cylindrical shield of the capper 314, so that the working and capping area of the capper receive a constant flow of with sterile air. A small portion of the filtered sterile air supplied by the filter device 321 gets into the security area 310.2.

From the filtering device 322, air is sucked out of the plenum 305 and introduced filtered in equal parts on both sides of the partition 318, i.e. in the form of sterile air into the portion of the clean room area 310.1 occupied by the rinser 312 and into the area occupied by the filling machine 313. The filtering device 323 also sucks air out of the plenum 305 and introduces it into the portion of the clean room area 310.1 occupied by the rinser 312, and in particular so that at least a portion of the airflow generated by the filtering device 323 flows downward along the inside of the partition, and thereby also forms an air curtain at the airlock opening, at which the bottles 302 to be filled are transported in the upright position from the security area 310.2 into the clean room area 310.1 or to the rinser 312. A similar air curtain of filtered and sterile air is also formed at the airlock opening, at which the filled and capped bottles 302 travel out of the clean room area 310.1 into the security area 310.2

As illustrated by the arrow that represents the airflow, the majority of the airflow generated by the filtering devices 321, 322, and 323 flows upward via the interior of the shields 312.1 and 313.1 and then returns to the plenum 305 at the top of the respective shield. A portion of the airflow generated by the filtering devices 321, 322, and 323 also flows through the openings 16 out of the clean room area 310.1 into the security area 310.2 and, like the sterile air from the filtering device 321, is introduced directly into the security area 310.2 and flows back into the plenum 305 via ventilation openings provided in the false floor/ceiling.

In another possible embodiment, a portion of the airflow generated by the filtering devices 321, 322, and 323 also flows through the openings out of the clean room area 310.1 into the security area 310.2 and, like the sterile air introduced directly into the security area 310.2 by the filtering device 321, flows back into the plenum 305 via at least one ventilation opening provided in the false floor/ceiling.

In the exemplary embodiment illustrated, the filtering devices 321, 322, and 323 have distribution ducts respectively for an optimal air distribution on the underside of the false floor/ceiling.

By means of the air circulation system formed by the filtering devices 320, 321, 322, and 323, the spaces that are supplied by these devices are maintained at a specified temperature, for example at a room or air temperature in the range of approximately twenty to twenty-two degrees Celsius and at a specified relative humidity, which can be less than or equal to seventy percent, for example.

In FIG. 5, 326 is an external air-conditioning unit which, among other things, has a filter stage and an air-conditioning stage, and by means of which the plenum 305 and the auxiliary space 307 are supplied with filtered and air-conditioned fresh air, i.e. air set to a temperature preferably in the range between twenty degrees Celsius and twenty-two degrees Celsius and to a relative humidity of equal to or less than seventy percent.

The air-conditioning unit 326 as well as the individual filtering devices 320, 321, 322 and 323 are regulated so that the air pressure in the sterile space 310 is in any case higher than atmosphere pressure, and higher than the air pressure in the additional rooms adjacent to the sterile room 310, such as the plenum 305, the auxiliary room 307, the personnel entry airlock, etc. The external air-conditioning unit 326 and the filtering devices 320 are also regulated so that the pressure in the plenum 305, in the auxiliary room 307 and in the personnel entry airlock and in the rooms adjacent to them is above the atmospheric pressure outside the housing 303. The air-conditioning unit 326 compensates for the air losses that occur on account of, among other things, the openings for the introduction and removal of containers and caps into and from the clean room.

The plant 301 is designed so that in the clean room 310.1, the Clean Room Class 100 (approximately 35,000 particles per m³ of air) required for aseptic production is achieved. On advantage of the plant 301, among others, is that the sterile space 310 itself has a relatively small volume, which significantly reduces, among other things, the costs for air conditioning and air treatment. An additional essential advantage is that in the event of any operational interruptions, the interiors of the shields 312.1 and 313.2 are accessible, i.e. repair and maintenance interventions can be carried out on the rinser 312 and on the filling machine 313, and namely via the upper cover 312.2 or 313.2 from the plenum 305. Because of the special routing of the airflow out of the areas surrounding the rinser 312 and the filling machine 313 upward through the shields 312.1 and 313.1, in the space 310 outside the shields, i.e. in the sterile area itself, the conditions of Clean Room Class 100 can be maintained even during repairs and maintenance operations on the rinser 312 and on the filling machine 313.

FIG. 5 also shows a working or waiting room 327 for the operating personnel. This room 327, which is also supplied with filtered, sterile air via a filtering device 320 from the auxiliary space 307, is accessible via the personnel entry airlock. The room 310 can be reached if necessary from the room 327 or via a corresponding door. In the partition 8 which also separates the room 327 from the room 310, there is also at least one view window 308.1.

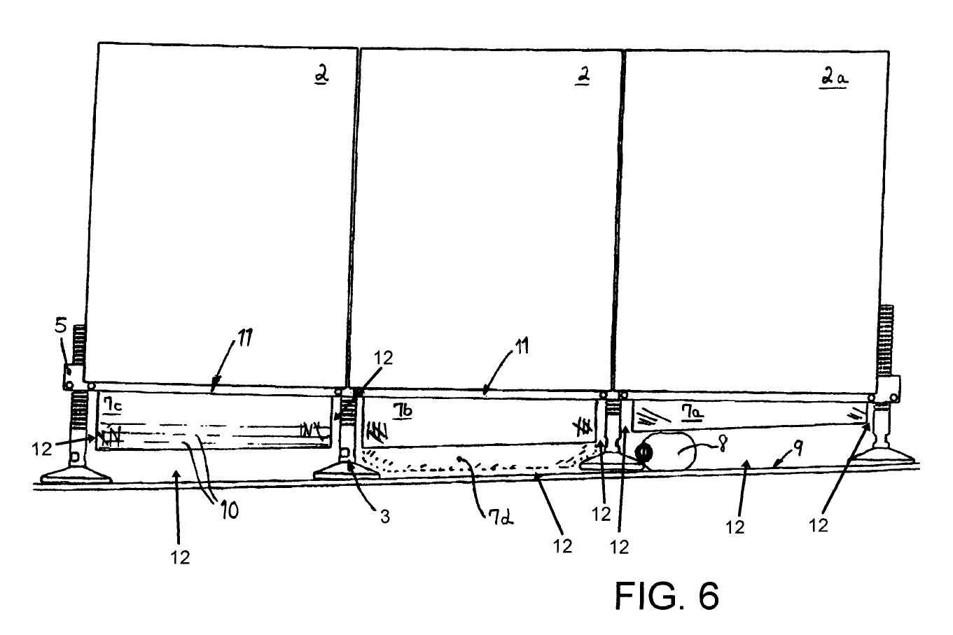

FIG. 6 shows an interior view of a partition wall part 1 according to at least one possible embodiment of the present application, comprising wall elements 2 and 2a, stand elements 3, bearing elements 5, gap plates 7a, 7b, 7c, and 7d, a bottle 8, the inclined ground surface 9, break points 10, supporting beams 11, and also seals or sealing arrangements 12. The seals or sealing arrangements 12 may border the gap plates 8 to hermetically seal the clean room when the gap plates 7 are disposed in a starting position, or when the gap plates 7 are disposed in a plane parallel or substantially parallel to the wall elements 2 and 2a. When the gap plates 7 pivot outwardly to permit the removal of dirt, debris, bottles, glass shards, and/or other contaminants, the hermetic seal may be broken. When the gap plates 7 pivot back into the starting position, the clean room may be hermetically sealed again. The seals or sealing arrangements 12 may be configured to help maintain overpressure in the clean room.

In at least one possible embodiment of the present application, the gap plates 7a, 7b, and 7c are configured to minimally open in order to permit contaminants, dirt, debris, glass shards, and/or bottles to be cleared from the clean room while also minimizing contaminants from entering the clean room. The gap plates 7a, 7b, and 7c may be configured to be weighted or to have a weight that restricts or minimizes the gap plates 7a, 7b, and 7c from pivoting and opening when the clean room is under positive pressure as sterile air flows through the clean room. In such an embodiment, the gap plates 7a, 7b, and 7c may be configured to pivot and/or open upon a high pressure water jet impinging upon and/or hitting the gap plates 7a, 7b, and 7c. The high pressure water jet then may provide a higher pressure than the positive pressure of the sterile air flowing through the clean room.

In one possible embodiment of the present application, the high pressure water jet may be part of an irrigation system that may be controlled within the clean room by a control device configured to control or run the plant and/or clean room. Pressurized clean air or sterile air may be fed or flowed through the clean room with a positive pressure. This positive pressure may be insufficient to cause the gap plates or pivotable plates 7 to pivot outwardly with respect to the interior of the clean room. This flow of air may restrict and/or minimize contaminants, dirt, and/or debris from entering the clean room. The hinges or pivot arrangements or pivot-permitting arrangements of the pivotable plates 7 may be configured to permit the pivotable plates 7 to pivot from the top and in one direction with respect to the interior of the clean room. The pivotable plates 7 may be held in a starting position by spring pressure, such that the pivotable plates 7 may stay in the starting position when the clean room is under positive pressure. The starting position may be when the pivotable plates 7 are in a parallel or substantially parallel plane with the glass walls 2. In at least one possible embodiment of the present application, the pivoting of the plates 7 may be motorized or automated. In at least one possible embodiment, the cleaning or flushing of the clean room by pivoting the plates 7 may occur during operation of the plant and/or clean room to promote efficiency of the filling plant. In another possible embodiment, the cleaning and/or flushing of the clean room may occur once the plant and/or clean room has been shut down.

In one possible embodiment of the present application, the gap or pivotable plates 7 may be configured to minimize or the openings to the clean room to restrict and/or minimize contaminants from entering the clean room. Contaminants may comprise dirt, debris, organisms, bottles, glass shards, and other unwanted or undesired objects.

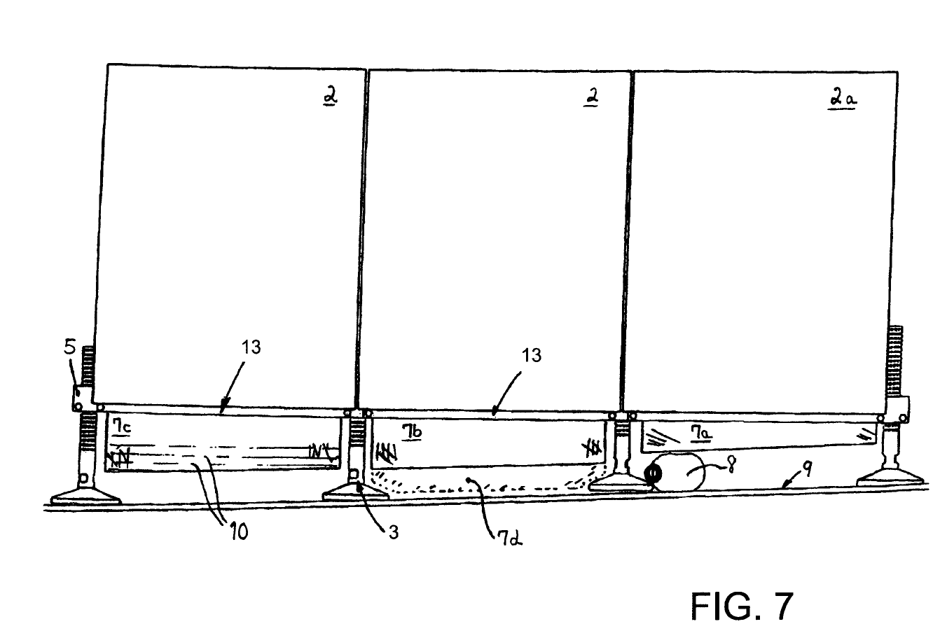

FIG. 7 shows an interior view of a partition wall part according to at least one possible embodiment of the present application, comprising wall elements 2 and 2a, stand elements 3, bearing elements 5, gap plates 7a, 7b, 7c, and 7d, a bottle 8, the inclined ground surface 9, break points 10, and also hinges or hinge means 13.

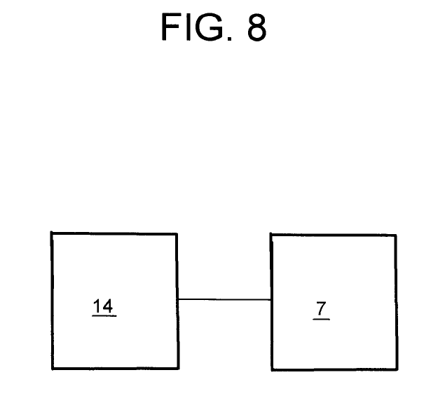

FIG. 8 is a block diagram which shows a nozzle or sprayer or high pressure liquid cleaner apparatus 14. The nozzle or sprayer 14 may be configured to spray water or other liquids or other fluids onto and/or toward a plate or plates 7.

The present application relates to a partition 1, in at least one possible embodiment, for housing packaging machines for food, for forming a clean room from a plurality of partition wall elements, in at least one embodiment glass panes, wherein cleaning by means of high-pressure cleaners should be simplified in that, in order to remove contamination and the like, the partition wall is designed so that no special manipulation of all the partitions is needed. The aim is achieved in that the glass panes or partition elements 2 are positioned on stand elements 3, 4, such that a gap is formed between the floor surface 9 and the lower edge of the partition wall elements 2, and that gap plates 7, movable by hinges and bridging the gap, are provided in said gap.

One feature or aspect of an embodiment is believed at the time of the filing of this patent application to possibly reside broadly in a partition wall 1, in at least one possible embodiment of the present application for the housing of packaging machines for foodstuffs, for forming a clean room from a plurality of partition wall elements, in at least one embodiment glass panels, wherein the glass panels or partition walls 2 are positioned in such a manner that a gap is formed between the floor surface 9 and the bottom edge of the partition wall elements 2 and in that gap plates 7 are provided in said gap, said gap plates bridging the gap and being displaceable by means of hinges.

Another feature or aspect of an embodiment is believed at the time of the filing of this patent application to possibly reside broadly in the device, wherein the partition wall elements 2 are provided with stand elements 3, 4 and in that the hinges of the gap plates 7 are provided on the stand elements 3, 4 of the partition wall 1.

Yet another feature or aspect of an embodiment is believed at the time of the filing of this patent application to possibly reside broadly in the device, wherein the mounting of the gap plates 7 makes it possible for said plates to pivot up in the direction of outside the interior space that is formed by the partition walls 1 whilst avoiding pivoting into the room that has been formed.

Still another feature or aspect of an embodiment is believed at the time of the filing of this patent application to possibly reside broadly in the device according to the present application, wherein the gap plates 7 are formed from a material that can easily be cut or bent for adapting to the respective installation situation.

A further feature or aspect of an embodiment is believed at the time of the filing of this patent application to possibly reside broadly in the device according to the present application wherein the position of use the width of the gap plates 7 is at least the width of a horizontal bottle.

Another feature or aspect of an embodiment is believed at the time of the filing of this patent application to possibly reside broadly in the device according to the present application, wherein by way of their outer edges, the gap plates 7 follow the course of the stands of the partition wall elements 2.

Yet another feature or aspect of an embodiment is believed at the time of the filing of this patent application to possibly reside broadly in a method of operating a clean room in a beverage bottling plant, which beverage bottling plant is configured to fill glass bottles with a liquid beverage material; said method comprising the steps of: flowing sterile air through said clean room with positive pressure and maintaining an overpressure in said clean room with respect to the ambient air around said beverage bottling plant; moving a first run of glass bottles through said beverage bottling plant; said first run comprising the steps of: moving glass bottles into a beverage bottle filling machine, which beverage bottle filling machine is disposed in a clean room of a beverage bottling plant; filling glass bottles with liquid beverage material in said beverage bottle filling machine in said clean room of said beverage bottling plant; moving filled glass bottles out of said beverage bottle filling machine in said clean room of said beverage bottling plant; moving filled glass bottles into a beverage bottle closing machine, which beverage bottle closing machine is disposed in said clean room of said beverage bottling plant; closing filled glass bottles with closures in said beverage bottle closing machine in said clean room of said beverage bottling plant; moving closed, filled glass bottles out of said beverage bottle closing machine in said clean room of said beverage bottling plant; dropping a small number of glass bottles out of said beverage bottle filling machine and said beverage bottle closing machine in said clean room, which small number of glass bottles is very substantially smaller than the total number of glass bottles being fed through said beverage bottle filling machine and said beverage bottle closing machine; breaking at least a portion of said small number of dropped glass bottles on the floor of said clean room and spilling bottle contents and scattering glass shards onto the floor of said clean room; cleaning said clean room and using a high pressure liquid cleaner apparatus to clean said clean room of said beverage bottling plant by impinging water on the glass walls of said clean room; impinging a high pressure water jet on said glass walls of said clean room; said glass walls comprising pivotable plates disposed at floor level, which pivotable plates are configured to swing outwardly with respect to the interior of said clean room to permit cleaning of dirt, debris, glass shards, and glass bottles from said clean room; said pivotable plates comprising pivot-permitting arrangements being configured and disposed to permit said pivotable plates to pivot outwardly with respect to the interior of said clean room and to restrict said pivotable plates from pivoting inwardly with respect to the interior said clean room, to minimize the introduction of contaminants into said clean room during operation of said clean room of said beverage bottling plant; said pivot-permitting arrangements comprising hinges; said positive pressure of said sterile air being insufficient to pivot said pivotable plates outwardly and being sufficient to minimize the introduction of contaminants into said clean room from outside said clean room through said pivotable plates during operation of said beverage bottle filling machine and said beverage bottle closing machine in said clean room of said beverage bottling plant; said pivotable plates being configured to pivot upon being impinged upon with a high pressure water jet, which high pressure water jet has a higher pressure than said positive pressure of said sterile air; said method comprising the further steps of: impinging said high pressure water jet on said pivotable plates and pivoting said pivotable plates and flushing out dirt, debris, glass shards, and glass bottles from said clean room; stopping said impinging and permitting said pivotable plates to pivot back into a starting position; moving a second run of glass bottles through said beverage bottling plant; said second run comprising the steps of: moving glass bottles into a beverage bottle filling machine, which beverage bottle filling machine is disposed in a clean room of a beverage bottling plant; filling glass bottles with liquid beverage material in said beverage bottle filling machine in said clean room of said beverage bottling plant; moving filled glass bottles out of said beverage bottle filling machine in said clean room of said beverage bottling plant; moving filled glass bottles into a beverage bottle closing machine, which beverage bottle closing machine is disposed in said clean room of said beverage bottling plant; closing filled glass bottles with closures in said beverage bottle closing machine in said clean room of said beverage bottling plant; moving closed, filled glass bottles out of said beverage bottle closing machine in said clean room of said beverage bottling plant; dropping a small number of glass bottles out of said beverage bottle filling machine and said beverage bottle closing machine in said clean room, which small number of glass bottles is very substantially smaller than the total number of glass bottles being fed through said beverage bottle filling machine and said beverage bottle closing machine; breaking at least a portion of said small number of dropped glass bottles on the floor of said clean room and spilling bottle contents and scattering glass shards onto the floor of said clean room; cleaning said clean room and using a high pressure liquid cleaner apparatus to clean said clean room of said beverage bottling plant by impinging water on the glass walls of said clean room; impinging a high pressure water jet on said glass walls of said clean room; impinging said high pressure water jet on said pivotable plates and pivoting said pivotable plates and flushing out dirt, debris, glass shards, and glass bottles from said clean room; and stopping said impinging and permitting said pivotable plates to pivot back into a starting position.

Still another feature or aspect of an embodiment is believed at the time of the filing of this patent application to possibly reside broadly in a method of operating a clean room in a foodstuff containing element filling plant, which foodstuff containing element filling plant is configured to fill foodstuff containing elements with foodstuff material; said method comprising the steps of: flowing pressurized clean air through said clean room with positive pressure and maintaining an overpressure in said clean room with respect to the ambient air around said foodstuff containing element filling plant; moving a first run of foodstuff containing elements through said foodstuff containing element filling plant; said first run comprising the steps of: moving foodstuff containing elements into said clean room of said foodstuff containing element filling plant; filling foodstuff containing elements with foodstuff material in said clean room of said foodstuff containing element filling plant; closing filled foodstuff containing elements in said clean room of said foodstuff containing element filling plant; moving closed, filled foodstuff containing elements out of said clean room of said foodstuff containing element filling plant; dislodging a small number of foodstuff containing elements in said clean room, which small number of foodstuff containing elements is very substantially smaller than the total number of foodstuff containing elements being fed through said clean room of said foodstuff containing element filling plant; cleaning said clean room and using a high pressure liquid cleaner apparatus to clean said clean room of said foodstuff containing element filling plant; pivoting pivotable plates, which pivotable plates extend downwardly from walls of said clean room toward the floor of said clean room, and pivoting said pivotable plates outwardly with respect to the interior of said clean room and cleaning out at least foodstuff containing elements from said clean room; and stopping said cleaning and pivoting said pivotable plates inwardly with respect to the interior of said clean room back into a starting position.

A further feature or aspect of an embodiment is believed at the time of the filing of this patent application to possibly reside broadly in a foodstuff containing element filling plant, which foodstuff containing element filling plant is configured to fill foodstuff containing elements with foodstuff material, said foodstuff containing element filling plant comprising: a clean room comprising walls and a floor; an air flowing arrangement being configured to flow pressurized clean air through said clean room with positive pressure to maintain an overpressure in said clean room with respect to the ambient air around said foodstuff containing element filling plant; a moving arrangement being configured to move foodstuff containing elements through said foodstuff containing element filling plant; a filling arrangement being disposed in said clean room of said foodstuff containing element filling plant; said filling arrangement being configured to fill foodstuff containing elements in said clean room of said foodstuff containing element filling plant; a closing arrangement being disposed in said clean room of said foodstuff containing element filling plant; said closing arrangement being configured to close foodstuff containing elements in said clean room of said foodstuff containing element filling plant; said moving arrangement being configured to move closed, filled foodstuff containing elements out of said clean room of said foodstuff containing element filling plant; at least one of: said filling arrangement, said closing arrangement, and foodstuff containing elements being configured to dislodge a small number of foodstuff containing elements out of at least one of: said filling arrangement and said closing arrangement in said clean room, which small number of foodstuff containing elements is very substantially smaller than the total number of foodstuff containing elements being fed through said filling arrangement and said closing arrangement; a cleaner apparatus being configured to clean said clean room of said foodstuff containing element filling plant; said walls comprising pivotable plates suspending from a lower portion of said walls toward said floor of said clean room; said pivotable plates comprising pivoting arrangements and being configured to pivot outwardly with respect to the interior of said clean room and permit cleaning out at least foodstuff containing elements from said clean room walls and said clean room floor; said pivotable plates being configured to pivot into a closed, starting position and remain closed upon pressurized clean air being flowed into said clean room by said air flowing arrangement.

Another feature or aspect of an embodiment is believed at the time of the filing of this patent application to possibly reside broadly in a method of operating a clean room in a beverage bottling plant, which beverage bottling plant is configured to fill glass bottles with a liquid beverage material; said method comprising the steps of: flowing sterile air through said clean room with positive pressure and maintaining an overpressure in said clean room with respect to the ambient air around said beverage bottling plant; moving a first run of glass bottles through said beverage bottling plant; said first run comprising the steps of: moving glass bottles into a beverage bottle filling machine, which beverage bottle filling machine is disposed in a clean room of a beverage bottling plant; filling glass bottles with liquid beverage material in said beverage bottle filling machine in said clean room of said beverage bottling plant; moving filled glass bottles out of said beverage bottle filling machine in said clean room of said beverage bottling plant; moving filled glass bottles into a beverage bottle closing machine, which beverage bottle closing machine is disposed in said clean room of said beverage bottling plant; closing filled glass bottles with closures in said beverage bottle closing machine in said clean room of said beverage bottling plant; moving closed, filled glass bottles out of said beverage bottle closing machine in said clean room of said beverage bottling plant; at least one of: said beverage bottle filling machine and said beverage bottle closing machine malfunctioning by dislodging a small number of glass bottles out of at least one of: said beverage bottle filling machine and said beverage bottle closing machine in said clean room and permitting said small number of glass bottles to fall to the floor of said clean room; breaking at least a portion of said small number of dropped glass bottles on the floor of said clean room and spilling bottle contents and scattering glass shards onto the floor of said clean room; cleaning said clean room and using a high pressure liquid cleaner apparatus to clean said clean room of said beverage bottling plant by impinging water on the glass walls and the floor of said clean room; impinging a high pressure water jet on said glass walls and said floor of said clean room; said glass walls comprising pivotable plates disposed at floor level, which pivotable plates are configured to swing outwardly with respect to the interior of said clean room to permit cleaning of dirt, debris, glass shards, and glass bottles from said clean room; said pivotable plates comprising pivot-permitting arrangements being configured and disposed to permit said pivotable plates to pivot outwardly with respect to the interior of said clean room and to restrict said pivotable plates from pivoting inwardly with respect to the interior said clean room, to minimize the introduction of contaminants into said clean room during operation of said clean room of said beverage bottling plant; said pivot-permitting arrangements comprising hinges; said positive pressure of said sterile air being insufficient to pivot said pivotable plates outwardly and being sufficient to minimize the introduction of contaminants into said clean room from outside said clean room through said pivotable plates during operation of said beverage bottle filling machine and said beverage bottle closing machine in said clean room of said beverage bottling plant; said pivotable plates being configured to pivot upon being impinged upon with a high pressure water jet, which high pressure water jet has a higher pressure than said positive pressure of said sterile air; said method comprising the further steps of: impinging said high pressure water jet on said pivotable plates and pivoting said pivotable plates and flushing out dirt, debris, glass shards, and glass bottles from said clean room; stopping said impinging and permitting said pivotable plates to pivot back into a starting position; moving a second run of glass bottles through said beverage bottling plant; said second run comprising the steps of: moving glass bottles into a beverage bottle filling machine, which beverage bottle filling machine is disposed in a clean room of a beverage bottling plant; filling glass bottles with liquid beverage material in said beverage bottle filling machine in said clean room of said beverage bottling plant; moving filled glass bottles out of said beverage bottle filling machine in said clean room of said beverage bottling plant; moving filled glass bottles into a beverage bottle closing machine, which beverage bottle closing machine is disposed in said clean room of said beverage bottling plant; closing filled glass bottles with closures in said beverage bottle closing machine in said clean room of said beverage bottling plant; moving closed, filled glass bottles out of said beverage bottle closing machine in said clean room of said beverage bottling plant; at least one of: said beverage bottle filling machine and said beverage bottle closing machine malfunctioning by dislodging a small number of glass bottles out of at least one of: said beverage bottle filling machine and said beverage bottle closing machine in said clean room and permitting said small number of glass bottles to fall to the floor of said clean room; breaking at least a portion of said small number of dropped glass bottles on the floor of said clean room and spilling bottle contents and scattering glass shards onto the floor of said clean room; cleaning said clean room and using a high pressure liquid cleaner apparatus to clean said clean room of said beverage bottling plant by impinging water on said glass walls and said floor of said clean room; impinging a high pressure water jet on said glass walls and said floor of said clean room; impinging said high pressure water jet on said pivotable plates and pivoting said pivotable plates and flushing out dirt, debris, glass shards, and glass bottles from said clean room; and stopping said impinging and permitting said pivotable plates to pivot back into a starting position.

Yet another feature or aspect of an embodiment is believed at the time of the filing of this patent application to possibly reside broadly in a method of operating a clean room in a foodstuff containing element filling plant, which clean room is configured to fill foodstuff containing elements with foodstuff material and which clean room comprises equipment to provide filled foodstuff containing elements; said method comprising the steps of: flowing pressurized clean air through said clean room with positive pressure and maintaining an overpressure in said clean room with respect to the ambient air around said foodstuff containing element filling plant; moving a first run of foodstuff containing elements through said foodstuff containing element filling plant; said first run comprising the steps of: moving foodstuff containing elements into said clean room of said foodstuff containing element filling plant; filling foodstuff containing elements with foodstuff material in said clean room of said foodstuff containing element filling plant; closing filled foodstuff containing elements in said clean room of said foodstuff containing element filling plant; moving closed, filled foodstuff containing elements out of said clean room of said foodstuff containing element filling plant; upon malfunctioning of equipment in said clean room by dislodging a number of foodstuff containing elements in said clean room, permitting said number of foodstuff containing elements to fall to the floor of said clean room; cleaning said clean room and using a high pressure liquid cleaner apparatus to clean said clean room of said foodstuff containing element filling plant; pivoting pivotable plates, which pivotable plates extend downwardly from walls of said clean room toward the floor of said clean room, and pivoting said pivotable plates outwardly with respect to the interior of said clean room and cleaning out at least foodstuff containing elements from said clean room; and stopping said cleaning and pivoting said pivotable plates inwardly with respect to the interior of said clean room back into a starting position.

Still another feature or aspect of an embodiment is believed at the time of the filing of this patent application to possibly reside broadly in a foodstuff containing element filling plant, which foodstuff containing element filling plant is configured to fill foodstuff containing elements with foodstuff material, said foodstuff containing element filling plant comprising: a clean room comprising walls and a floor; an air flowing arrangement being configured to flow pressurized clean air through said clean room with positive pressure to maintain an overpressure in said clean room with respect to the ambient air around said foodstuff containing element filling plant; a moving arrangement being configured to move foodstuff containing elements through said foodstuff containing element filling plant; a filling arrangement being disposed in said clean room of said foodstuff containing element filling plant; said filling arrangement being configured to fill foodstuff containing elements in said clean room of said foodstuff containing element filling plant; a closing arrangement being disposed in said clean room of said foodstuff containing element filling plant; said closing arrangement being configured to close foodstuff containing elements in said clean room of said foodstuff containing element filling plant; said moving arrangement being configured to move closed, filled foodstuff containing elements out of said clean room of said foodstuff containing element filling plant; at least one of: said filling arrangement, said closing arrangement, and foodstuff containing elements, upon malfunctioning by at least dislodging a number of foodstuff containing elements out of at least one of: said filling arrangement and said closing arrangement in said clean room, being configured to permit at least said foodstuff containing element to fall to said floor of said clean room, which number of foodstuff containing elements is very substantially smaller than the total number of foodstuff containing elements being fed through said filling arrangement and said closing arrangement; a cleaner apparatus being configured to clean said clean room of said foodstuff containing element filling plant; said walls comprising pivotable plates suspending from a lower portion of said walls toward said floor of said clean room; said pivotable plates comprising pivoting arrangements and being configured to pivot outwardly with respect to the interior of said clean room and permit cleaning out at least foodstuff containing elements from said clean room walls and said clean room floor; said pivotable plates being configured to pivot into a closed, starting position and remain closed upon pressurized clean air being flowed into said clean room by said air flowing arrangement.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, except for the exceptions indicated herein, which were cited in the International Search Report dated Oct. 29, 2009, and/or cited elsewhere are hereby incorporated by reference as if set forth in their entirety herein, as follows: FR 2 411 931 A, having the following French title “Cloisons amovibles,” published on Jul. 13, 1979; DE 40 04 200 A1, having the English translation “Multifunctional wall unit for office equipment—has frame with support for work surface panels and shelves,” published on Aug. 14, 1991; DE 34 22 704 A1, having the English translation “Partition which can be offset and comprises wall elements,” published on Dec. 19, 1985; U.S. Pat. No. 2,886,147 A, having the title “Partition structure,” published on May 12, 1959; and DE 200 18 840 U1, having the title “Behandlungs-oder Fertigungsanlage and Maschinenschutzvorrichtung,” published on Feb. 8, 2001.

All of the patents, patent applications or patent publications, except for the exceptions indicated herein, which were cited in the German Office Action dated Oct. 9, 2008, and/or cited elsewhere are hereby incorporated by reference as if set forth in their entirety herein, as follows: EP 0 185 188 A2, having the English translation “Cabin,” published on Jun. 25, 1986; DE 20 2005 002 866 U1, having the English translation “Building set for construction of a clean room comprises arrays of stainless steel supports with fixing elements for glass panes and/or insulation panels,” published on Sep. 29, 2005; DE 20 2004 001 619 U1, having the English translation “Plant for filling bottles under aseptic conditions with foodstuffs or pharmaceuticals comprises filling machine and sealing machine in clean room environment, each machine having housing connected to air outlet,” published on May 19, 2004; DE 197 23 954 A1, having the English translation “Clean room,” published on Mar. 26, 1998.

U.S. patent application Ser. No. 12/362,633, filed on Jan. 30, 2009, having inventors Daryoush SANGI and Thomas HEROLD, Attorney Docket No. NHL-HOL-176, and title “ASEPTIC BEVERAGE BOTTLE FILLING PLANT WITH A CLEAN ROOM ARRANGEMENT ENCLOSING THE ASEPTIC BEVERAGE BOTTLE FILLING PLANT AND A METHOD OF OPERATING SAME, AND AN ASEPTIC CONTAINER FILLING PLANT WITH A CLEAN ROOM ARRANGEMENT ENCLOSING THE ASEPTIC CONTAINER FILLING PLANT, AND A METHOD OF OPERATING SAME,” and its corresponding Federal Republic of Germany Patent Application No. DE 10 2006 036 475.9, filed on Aug. 4, 2006, and International Patent Application No. PCT/EP2007/006805, filed on Aug. 1, 2007, are hereby incorporated by reference as if set forth in their entirety herein.

Some examples of pivot pins, which may be utilized or adapted for use in at least one possible embodiment of the present application, may possibly be found in the following U.S. Pat. No. 7,728,248, having the title “Method for forming precision clockplate with pivot pins,” published on Jun. 1, 2010; No. 6,065,719, having the title “Main landing gear having tilting timing of main gear pivot pins,” published on May 23, 2000; No. 5,930,991, having the title “Double door thrust reverser assembly with strut-carrier door pivot pins,” published on Aug. 3, 1999; No. 5,826,825, having the title “Automatically actuated cargo and personnel snatching apparatus with distance sensos, magnets and pivot pins for assistance,” published on Oct. 27, 1998; No. 5,425,434, having the title “Bicycle brake with two pivot pins,” published on Jun. 20, 1995; and No. 5,188,523, having the title “Internal gear machine having a filler piece with pivot pins and a separating gap,” published on Feb. 23, 1993.

Some examples of pivoting joints, connectors, or similar mechanisms, that may possibly be utilized or adapted for use in at least one possible embodiment may possibly be found in the following U.S. Pat. Nos. 7,735,797, entitled, “Adjustable pivoting device for a panel display;” 7,576,504, entitled, “Pivoting and barrier locking operator system;” 7,478,789, entitled, “Pivoting mechanism for stand and electronic apparatus;” and 7,170,285, entitled, “Ball and socket joint with pivoting angle sensor for detecting the relative angular position of the joint housing and the ball pivot.”

Some examples of nozzle structures that may possibly be utilized or possibly adapted for use in at least one possible embodiment of the present application may possibly be found in the following U.S. Pat. No. 6,042,026 issued to Buehler, II on Mar. 28, 2000; No. 6,394,366 issued to Adams on May 28, 2002; No. 6,402,062 issued to Bendig et al. on Jun. 11, 2002; No. 6,616,072 issued to Harata et al. on Sep. 9, 2003; No. 6,666,386 issued to Huang on Dec. 23, 2003; and No. 6,681,498 issued to Steffan on Jan. 27, 2004.

U.S. patent application Ser. No. 11/050,484, filed on Feb. 3, 2005, having inventor Ludwig CLUSSERATH, Attorney Docket No. NHL-HOL-101, and title “Beverage bottling plant for filling bottles with a liquid beverage material and an aseptic bottling system for the aseptic bottling of a liquid material,” and its corresponding Federal Republic of Germany Patent Application No. DE 10 2004 005 342.1, filed on Feb. 2, 2004, and U.S. patent application Ser. No. 12/362,633, filed on Jan. 30, 2009, having inventor Daryoush SANGI, Attorney Docket No. NHL-HOL-176, and title “ASEPTIC BEVERAGE BOTTLE FILLING PLANT WITH A CLEAN ROOM ARRANGEMENT ENCLOSING THE ASEPTIC BEVERAGE BOTTLE FILLING PLANT AND A METHOD OF OPERATING SAME, AND AN ASEPTIC CONTAINER FILLING PLANT WITH A CLEAN ROOM ARRANGEMENT ENCLOSING THE ASEPTIC CONTAINER FILLING PLANT, AND A METHOD OF OPERATING SAME,” and its corresponding Federal Republic of Germany Patent Application No. DE 10 2006 036 476.7, filed on Aug. 4, 2006, and International Patent Application No. PCT/EP2007/006806, filed on Aug. 1, 2007, having WIPO Publication No. WO 2008/014992 and inventor Daryoush SANGI are hereby incorporated by reference as if set forth in their entirety herein.

The patents, patent applications, and patent publications listed above in the preceding paragraphs are herein incorporated by reference as if set forth in their entirety except for the exceptions indicated herein. The purpose of incorporating U.S. patents, Foreign patents, publications, etc. is solely to provide additional information relating to technical features of one or more embodiments, which information may not be completely disclosed in the wording in the pages of this application. However, words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments of the patents, patent applications, and patent publications, are not considered to be incorporated by reference herein.

The corresponding foreign and international patent publication applications, namely, Federal Republic of Germany Patent Application No. 10 2007 062 813.9, filed on Dec. 21, 2007, having inventor Thomas DETEMPLE, and DE-OS 10 2007 062 813.9 and DE-PS 10 2007 062 813.9, and International Application No. PCT/EP2008/009918, filed on Nov. 22, 2008, having WIPO Publication No. WO 2009/083072 and inventor Thomas DETEMPLE, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, except for the exceptions indicated herein, are hereby incorporated by reference as if set forth in their entirety herein.

The purpose of incorporating the corresponding foreign equivalent patent applications, that is, PCT/EP2008/009918 and German Patent Application DE 10 2007 062 813.9, is solely for the purpose of providing a basis of correction of any wording in the pages of the present application, which may have been mistranslated or misinterpreted by the translator. However, words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned word in this sentence, when not used to describe technical features of one or more embodiments of the patents, patent applications, and patent publications, are not generally considered to be incorporated by reference herein.

Statements made in the original foreign patent applications PCT/EP2008/009918 and DE 10 2007 062 813.9 from which this patent application claims priority which do not have to do with the correction of the translation in this patent application are not to be included in this patent application in the incorporation by reference.

Any statements about admissions of prior art in the original foreign patent applications PCT/EP2008/009918 and DE 10 2007 062 813.9 are not to be included in this patent application in the incorporation by reference, since the laws relating to prior art in non-U.S. Patent Offices and courts may be substantially different from the Patent Laws of the United States.

All of the references and documents cited in any of the documents cited herein, except for the exceptions indicated herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. A method of operating a clean room in a beverage bottling plant, which beverage bottling plant is configured to fill glass bottles with a liquid beverage material;
said method comprising the steps of:
flowing sterile air through said clean room with positive pressure and maintaining an overpressure in said clean room with respect to the ambient air around said beverage bottling plant;
moving a first run of glass bottles through said beverage bottling plant;
said first run comprising the steps of:
moving glass bottles into a beverage bottle filling machine, which beverage bottle filling machine is disposed in a clean room of a beverage bottling plant;
filling glass bottles with liquid beverage material in said beverage bottle filling machine in said clean room of said beverage bottling plant;
moving filled glass bottles out of said beverage bottle filling machine in said clean room of said beverage bottling plant;
moving filled glass bottles into a beverage bottle closing machine, which beverage bottle closing machine is disposed in said clean room of said beverage bottling plant;
closing filled glass bottles with closures in said beverage bottle closing machine in said clean room of said beverage bottling plant;
moving closed, filled glass bottles out of said beverage bottle closing machine in said clean room of said beverage bottling plant;
at least one of: said beverage bottle filling machine and said beverage bottle closing machine malfunctioning by dislodging a small number of glass bottles out of at least one of: said beverage bottle filling machine and said beverage bottle closing machine in said clean room and permitting said small number of glass bottles to fall to the floor of said clean room;
breaking at least a portion of said small number of dropped glass bottles on the floor of said clean room and spilling bottle contents and scattering glass shards onto the floor of said clean room;
cleaning said clean room and using a high pressure liquid cleaner apparatus to clean said clean room of said beverage bottling plant by impinging water on the glass walls and the floor of said clean room;
impinging a high pressure water jet on said glass walls and said floor of said clean room;
said glass walls comprising pivotable plates disposed at floor level, which pivotable plates are configured to swing outwardly with respect to the interior of said clean room to permit cleaning of dirt, debris, glass shards, and glass bottles from said clean room;
said pivotable plates comprising pivot-permitting arrangements being configured and disposed to permit said pivotable plates to pivot outwardly with respect to the interior of said clean room and to restrict said pivotable plates from pivoting inwardly with respect to the interior said clean room, to minimize the introduction of contaminants into said clean room during operation of said clean room of said beverage bottling plant;
said pivot-permitting arrangements comprising hinges;
said positive pressure of said sterile air being insufficient to pivot said pivotable plates outwardly and being sufficient to minimize the introduction of contaminants into said clean room from outside said clean room through said pivotable plates during operation of said beverage bottle filling machine and said beverage bottle closing machine in said clean room of said beverage bottling plant;
said pivotable plates being configured to pivot upon being impinged upon with a high pressure water jet, which high pressure water jet has a higher pressure than said positive pressure of said sterile air;
said method comprising the further steps of:
impinging said high pressure water jet on said pivotable plates and pivoting said pivotable plates and flushing out dirt, debris, glass shards, and glass bottles from said clean room;
stopping said impinging and permitting said pivotable plates to pivot back into a starting position;
moving a second run of glass bottles through said beverage bottling plant;
said second run comprising the steps of:
moving glass bottles into a beverage bottle filling machine, which beverage bottle filling machine is disposed in a clean room of a beverage bottling plant;
filling glass bottles with liquid beverage material in said beverage bottle filling machine in said clean room of said beverage bottling plant;
moving filled glass bottles out of said beverage bottle filling machine in said clean room of said beverage bottling plant;
moving filled glass bottles into a beverage bottle closing machine, which beverage bottle closing machine is disposed in said clean room of said beverage bottling plant;
closing filled glass bottles with closures in said beverage bottle closing machine in said clean room of said beverage bottling plant;
moving closed, filled glass bottles out of said beverage bottle closing machine in said clean room of said beverage bottling plant;
at least one of: said beverage bottle filling machine and said beverage bottle closing machine malfunctioning by dislodging a small number of glass bottles out of at least one of: said beverage bottle filling machine and said beverage bottle closing machine in said clean room and permitting said small number of glass bottles to fall to the floor of said clean room;
breaking at least a portion of said small number of dropped glass bottles on the floor of said clean room and spilling bottle contents and scattering glass shards onto the floor of said clean room;
cleaning said clean room and using a high pressure liquid cleaner apparatus to clean said clean room of said beverage bottling plant by impinging water on said glass walls and said floor of said clean room;
impinging a high pressure water jet on said glass walls and said floor of said clean room;
impinging said high pressure water jet on said pivotable plates and pivoting said pivotable plates and flushing out dirt, debris, glass shards, and glass bottles from said clean room; and
stopping said impinging and permitting said pivotable plates to pivot back into a starting position.

2. The method according to claim 1, wherein:
said glass walls comprise stand elements configured and disposed to adjustably hold said glass walls and said pivotable plates.

3. The method according to claim 2, wherein each of said pivotable plates comprises a height extending from said wall to said floor, which height is greater than or equal to the diameter of a horizontal glass bottle.

4. The method according to claim 3, wherein:
each of said pivotable plates comprises side edges disposed adjacent said stand elements; and
said side edges are configured to align with said stand elements of said glass walls.

5. The method according to claim 4, wherein said step of flowing sterile air and maintaining an overpressure further comprises maintaining said overpressure using seals disposed around said pivotable plates to minimize sterile air from leaking out of said clean room.

6. The method according to claim 5, wherein said pivotable plates comprise a material, which material can easily be cut or bent for adapting to the respective installation situation.

7. A method of operating a clean room in a foodstuff containing element filling plant, which clean room is configured to fill foodstuff containing elements with foodstuff material and which clean room comprises equipment to provide filled foodstuff containing elements;
said method comprising the steps of:
flowing pressurized clean air through said clean room with positive pressure and maintaining an overpressure in said clean room with respect to the ambient air around said foodstuff containing element filling plant;
moving a first run of foodstuff containing elements through said foodstuff containing element filling plant;
said first run comprising the steps of:
moving foodstuff containing elements into said clean room of said foodstuff containing element filling plant;
filling foodstuff containing elements with foodstuff material in said clean room of said foodstuff containing element filling plant;
closing filled foodstuff containing elements in said clean room of said foodstuff containing element filling plant;
moving closed, filled foodstuff containing elements out of said clean room of said foodstuff containing element filling plant;
upon malfunctioning of equipment in said clean room by dislodging a number of foodstuff containing elements in said clean room, permitting said number of foodstuff containing elements to fall to the floor of said clean room;
cleaning said clean room and using a high pressure liquid cleaner apparatus to clean said clean room of said foodstuff containing element filling plant;
pivoting pivotable plates, which pivotable plates extend downwardly from walls of said clean room toward the floor of said clean room, and pivoting said pivotable plates outwardly with respect to the interior of said clean room and cleaning out at least foodstuff containing elements from said clean room; and
stopping said cleaning and pivoting said pivotable plates inwardly with respect to the interior of said clean room back into a starting position.

8. The method according to claim 7, wherein:
said pivotable plates comprise hinge means; and
said hinge means of said pivotable plates are disposed on said walls.

9. The method according to claim 8, wherein said hinge means of said pivotable plates are configured to:
permit said pivotable plates to pivot outwardly with respect to the interior of said clean room; and
restrict said pivotable plates from pivoting inwardly with respect to the interior of said clean room and from entering the interior of said clean room.

10. The method according to claim 9, wherein:
each of said pivotable plates comprises a height extending from said wall to said floor, which height is equal to or greater than a dimension of a foodstuff containing element; and
said foodstuff containing elements comprise one of: plastic bottles, plastic beverage bottles, glass bottles, glass beverage bottles, and pouches for containing foodstuff.

11. The method according to claim 10, wherein:
said walls comprise wall supports configured and disposed to adjustably hold said walls and said pivotable plates;
each of said pivotable plates comprises side edges disposed adjacent said wall supports; and
said side edges of said pivotable plates align with said wall supports of said walls upon said pivotable plates being vertical and being in said starting position.

12. The method according to claim 11, wherein said step of flowing pressurized clean air and maintaining an overpressure further comprises maintaining said overpressure using seal arrangements disposed around said pivotable plates to minimize pressurized clean air from leaking out of said clean room.

13. The method according to claim 12, wherein said pivotable plates comprise a material, which material can easily be cut or bent for adapting to the respective installation situation.

14. A foodstuff containing element filling plant, which foodstuff containing element filling plant is configured to fill foodstuff containing elements with foodstuff material, said foodstuff containing element filling plant comprising:
a clean room comprising walls and a floor;
an air flowing arrangement being configured to flow pressurized clean air through said clean room with positive pressure to maintain an overpressure in said clean room with respect to the ambient air around said foodstuff containing element filling plant;
a moving arrangement being configured to move foodstuff containing elements through said foodstuff containing element filling plant;
a filling arrangement being disposed in said clean room of said foodstuff containing element filling plant;
said filling arrangement being configured to fill foodstuff containing elements in said clean room of said foodstuff containing element filling plant;
a closing arrangement being disposed in said clean room of said foodstuff containing element filling plant;
said closing arrangement being configured to close foodstuff containing elements in said clean room of said foodstuff containing element filling plant;
said moving arrangement being configured to move closed, filled foodstuff containing elements out of said clean room of said foodstuff containing element filling plant;
at least one of: said filling arrangement, said closing arrangement, and foodstuff containing elements, upon malfunctioning by at least dislodging a number of foodstuff containing elements out of at least one of: said filling arrangement and said closing arrangement in said clean room, being configured to permit at least said foodstuff containing element to fall to said floor of said clean room, which number of foodstuff containing elements is very substantially smaller than the total number of foodstuff containing elements being fed through said filling arrangement and said closing arrangement;
a cleaner apparatus being configured to clean said clean room of said foodstuff containing element filling plant;
said walls comprising pivotable plates suspending from a lower portion of said walls toward said floor of said clean room;
said pivotable plates comprising pivoting arrangements and being configured to pivot outwardly with respect to the interior of said clean room and permit cleaning out at least foodstuff containing elements from said clean room walls and said clean room floor;
said pivotable plates being configured to pivot into a closed, starting position and remain closed upon pressurized clean air being flowed into said clean room by said air flowing arrangement.

15. The foodstuff containing element filling plant according to claim 14, wherein:
said pivoting arrangements of said pivotable plates comprise hinge means; and
said hinge means of said pivotable plates are disposed on said stand elements of said clean room walls.

16. The foodstuff containing element filling plant according to claim 15, wherein said hinge means of said pivotable plates are configured to:
permit said pivotable plates to pivot outwardly with respect to the interior of said clean room; and
restrict said pivotable plates from pivoting inwardly with respect to the interior of said clean room and from entering the interior of said clean room.

17. The foodstuff containing element filling plant according to claim 16, wherein:
each of said pivotable plates comprises a height extending from said wall to said floor, which height is equal to or greater than a dimension of a foodstuff containing element; and
said foodstuff containing elements comprise one of: plastic bottles, plastic beverage bottles, glass bottles, glass beverage bottles, and pouches for containing foodstuff.

18. The foodstuff containing element filling plant according to claim 17, wherein:
said walls of said clean room comprise wall supports, which wall supports are configured and disposed to adjustably hold said clean room walls and said pivotable plates;
each of said pivotable plates comprises side edges disposed adjacent said wall supports; and
said side edges of said pivotable plates are configured to align with said wall supports of said clean room walls upon said pivotable plates being vertical and being in the starting position.

19. The foodstuff containing element filling plant according to claim 18, wherein:
said walls of said clean room comprise seal arrangements, which seal arrangements are configured to maintain an overpressure in said clean room and to minimize sterile air from leaking out of said clean room.

20. The foodstuff containing element filling plant according to claim 19, wherein said pivotable plates comprise a material, which material can easily be cut or bent for adapting to the respective installation situation.
